(19) United States
(12) Patent Application Publication
(10) Pub. No.: US 2011/0119489 A1
(43) Pub. Date: May 19, 2011

(54) NETWORK AND METHOD FOR ESTABLISHING A SECURE NETWORK

(75) Inventors: Oscar Garcia Morchon, Aachen (DE); Heribert Baldus, Aachen (DE); Axel Guenther Huebner, Muenchen (DE); Bozena Erdmann, Aachen (DE)

(73) Assignee: KONINKLIJKE PHILIPS ELECTRONICS N.V., EINDHOVEN (NL)

(21) Appl. No.: 12/674,953

(22) PCT Filed: Sep. 4, 2008
(86) PCT No.: PCT/IB08/53575

§ 371 Date: Feb. 24, 2010

(30) Foreign Application Priority Data
Sep. 7, 2007 (EP) 07115895.0

(51) Int. Cl. H04L 9/32

(52) U.S. Cl. 713/169

(57) ABSTRACT

The invention relates to a network with a first node (102) comprising first pre-distributed keying material being assigned to the first node before the first node is connected to the network and a second node (104) comprising second pre-distributed keying material being assigned to the second node before the second node is connected to the network. The first node is configured to establish a secure communication (112) to the second node based on the first and second pre-distributed keying materials, without relying on a trust center (108). Pre-distributed keying materials can be replaced in a secure manner with post-deployed keying materials by the network trust center. Nodes can establish further secure communications based on post-deployed keying materials.

The invention relates in general to a network, to a method for establishing a secure network and to a node for a network.

Wireless control networks (WCNs) aim at removing wires in buildings. By using wireless control networks, a control system can be made more flexible and costs, in particular the costs of installation, may be reduced.

FIG. 6 shows a simple wireless control network comprising a wireless switch 601 and several wireless lighting nodes 602, 604, 606. The wireless switch 601 controls wirelessly the wireless lighting nodes 602, 604, 606. For example, the switch 601 may switch the lighting nodes 602, 604, 606 “on” or “off”. The lighting node 602 may be a first lighting system, the lighting node 604 may be a second lighting system and the lighting node 606 may be a third lighting system. More complex wireless control networks might be composed of hundreds of wireless control nodes, e.g. lamps, meters, sensors, communicating in an ad hoc manner.

Wireless control networks face new security threats, like message injection or network-level intrusion. In this context, the provision of basic security services, namely authentication, authorization, integrity and sometimes confidentiality, is fundamental. Authentication must validate that a node belongs to the wireless control network, so that an attacker cannot introduce false information, such as changing configuration of the node. Authorization must authenticate that a node is allowed to perform a specific task, such as turning on the lights. Integrity must ensure that messages sent between wireless control network nodes are not modified by third parties. Confidentiality guarantees that the message content is known only to the intended parties. Those security services cannot be guaranteed without a consistent and practical key distribution architecture (KDA) for wireless control networks. However, the definition of a consistent and practical key distribution architecture is challenging due to the strict operational requirements and technical restrictions of wireless control networks.

US2007/0147619A1 is directed to a system for managing security keys in a wireless network including a manufacturer certification authority for providing a signed digital certificate for installation into a new network element at the manufacturer's facility prior to the new network element being installed and initialized in the network. The system includes a service provider certification authority for managing certificates and files used by the network elements to communicate securely within the network.

It is an object of the present invention to provide an improved network, an improved method for establishing a network and an improved node for a network.

The object is solved by the independent claims. Further embodiments are shown by the dependent claims.

A basic idea of the invention is the definition of a practical and efficient key distribution architecture for wireless control networks in which the participation of an online trust center is not required in the key establishment process. Thus, key establishment occurs in an ad hoc manner. In this manner, the communication load around the online trust center is reduced and a system with a single point of failure is avoided. Furthermore, the inventive key distribution architecture is highly scalable and allows any pair of wireless control network nodes to agree on a symmetric secret, so that further security services can be provided based on this secret.

The inventive approach can be applied not only to wireless control networks but also to 802.15.4/ZigBee® based networks, and in general to wireless sensor networks applications in which the online trust center is only occasionally accessible.

The inventive approach avoids the disadvantages of key distribution architectures based on an online trust center or a simple key pre-distribution scheme.

Trust center approaches overload resources, like routing tables of neighbour routers or communication links, around the online trust center in large networks. The overload is generated due to the requirement that a new pair of nodes which wants to establish a new key, firstly has to get a common application master key from the online trust center. Further, in an online trust center approach, the number of nodes with which another node can securely communicate, is limited by the node memory, as a node needs to store an application master key with each and every node, it wants to securely communicate. Moreover, the online trust center represents a single point of failure. If it is attacked or it breaks down, nodes cannot establish a secure communication anymore.

Key pre-distribution schemes present an alternative key distribution architecture for wireless control networks. Key pre-distribution schemes are based on the pre-distribution of some kind of keying material before node deployment. After node deployment, nodes can establish secure communications by exploiting the pre-distributed keying material. Therefore, key pre-distribution schemes do not require the intervention of an online trust center in the key establishment phase. Key pre-distribution schemes present certain limitations when applied to commercial applications, such as wireless control networks, as the keying material is pre-distributed at the factory before a product is sold or even known to which wireless control network the nodes will belong to. This fact is not desirable as nodes in different networks might be able to communicate and to authenticate to each other. Thus, key pre-distribution schemes limit the configurability of a network as nodes get keying material at the factory before deployment.

The inventive approach reduces the overload of resources around the online trust center in a wireless control network. This allows nodes to agree on a common secret without requiring an online access to the trust center. Thus, nodes can authenticate to each other in an ad hoc manner. The inventive approach has very low memory requirements to store keying material that enables any pair of nodes to agree on a secret. Further, nodes belonging to different wireless control networks cannot establish a secure communication. For example, nodes belonging to different Security Domains (SDs) may not establish a secure communication. Moreover, the inventive key distribution architecture can be applied to improve and enhance the security protocol of the current general ZigBee® specification.

According to an embodiment of the invention, a network is provided, comprising:
a first node comprising first pre-distributed keying material being assigned to the first node before the first node is connected to the network; and
a second node comprising second pre-distributed keying material being assigned to the second node before the second node is connected to the network;
wherein the first node is configured to establish a secure communication to the second node based on the first and second pre-distributed keying material, without relying on a trust center.

The first and second pre-distributed keying material may each comprise a node identifier, a secret key and a basic set of keying material. The node identifier allows an unambiguous node identification, and the corresponding secret key allows authenticating the node by means of an authentication handshake.

The first and second pre-distributed keying material may be configured to be interoperable if the first and second nodes are assigned to the same network and may not be interoperable if the first and second nodes are assigned to different networks. This allows preventing communication between nodes belonging to different security domains.

The first and second pre-distributed keying material may be assigned to the first and second node during manufacturing of the first and second node. Thus, it is ensured that an invader does not get knowledge of the pre-distributed keying material while the pre-distributed keying material is provided to the nodes.

According to an embodiment, the network may further comprise the trust center being configured to authenticate the first and the second nodes based on the first and second pre-distributed keying material.

The trust center may be configured to provide a first post-distributed keying material to the first node and a second post-distributed keying material to the second node, wherein the first post-distributed keying material is correlated to the second post-distributed keying material and wherein the first node is configured to establish the secure communication to the second node based on the first and second post-distributed keying material, without further relying on the trust center. This allows providing the nodes of a network with network specific keying material.

The first and second nodes may be configured to replace the first and second pre-distributed keying materials by the first and second post-distributed keying materials. This allows changing or updating the keying material of the nodes.

The first and second pre-distributed and/or post-distributed keying materials may be based on a λ-secure approach as described by R. Blom, “An Optimal Class of Symmetric Key Generation Systems” Advances in Cryptology: Proc. Eurocrypt'84, pp. 335-338, 1984 and C. Blundo, A. D. Santis, A. Herzberg, S. Kutten, U. Vaccaro and M. Yung, “Perfectly-Secure Key Distribution for Dynamic Conferences”, Proc. Conf. Advances in Cryptology (Crypto'92), E. F. Brickell, ed., pp. 471-486, 1992. These approaches allow a pair of nodes to agree on a secret while guaranteeing that nodes lesser than do not compromise the security of the system. Pre-distributed and/or post-distributed keying material may be also based on other key pre-distribution schemes (KPS) such as a random KPS or a pair public/private key where the public key is authenticated by a certificate issued by the trust center

Further, the first and second nodes may be configured to use the first and second pre-distributed and/or post-distributed keying materials to agree on a common secret key usable by the first node to establish the secure communication to the second node.

The network may be a wireless control network. The inventive approach may find application in wireless control networks. Especially, it is applicable to any large-scale network, like lighting network, meter reading network, etc. In general, this invention can be applied to any kind of 802.15.4/ZigBee® network. Additionally, the key distribution architecture might be applied to other wireless sensor network applications in which the trust center is occasionally online.

The first and second nodes may be ZigBee® nodes.

According to a further embodiment of the invention, a node for a network is provided, comprising:
a pre-distributed keying material being assigned to the node before the node is connected to the network;
wherein the node is configured to establish a secure communication to at least one further node of the network when the node is connected to the network and
wherein the node is configured to establish the secure communication based on the pre-distributed keying material without relying on a trust center.

According to a further embodiment of the invention, a method for establishing a network is provided, comprising the steps of:
providing a first node comprising first pre-distributed keying material being assigned to the first node before the first node is connected to the network;
providing a second node comprising second pre-distributed keying material being assigned to the second node before the second node is connected to the network; and
establishing a secure communication between the first and the second node based on the first and second pre-distributed keying materials, without relying on a trust center.

According to a further embodiment of the invention, a computer program may be provided, which is enabled to carry out the above method according to the invention when executed by a computer. This allows realizing the inventive approach in a compiler program.

According to a further embodiment of the invention, a record carrier storing a computer program according to the invention may be provided, for example a CD-ROM, a DVD, a memory card, a diskette, or a similar data carrier suitable to store the computer program for electronic access.

These and other aspects of the invention will be apparent from and elucidated with reference to the embodiments described hereinafter.

The invention will be described in more detail hereinafter with reference to exemplary embodiments. However, the invention is not limited to these exemplary embodiments.

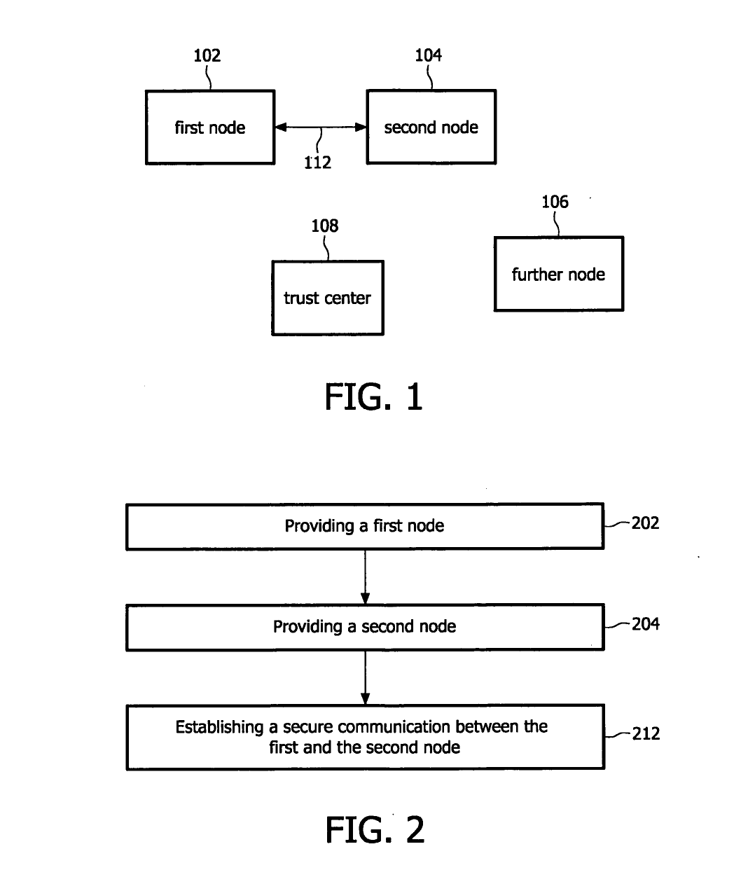

FIG. 1 shows a network according to the invention;

FIG. 2 shows a flow diagram of a method for establishing a network according to the invention;

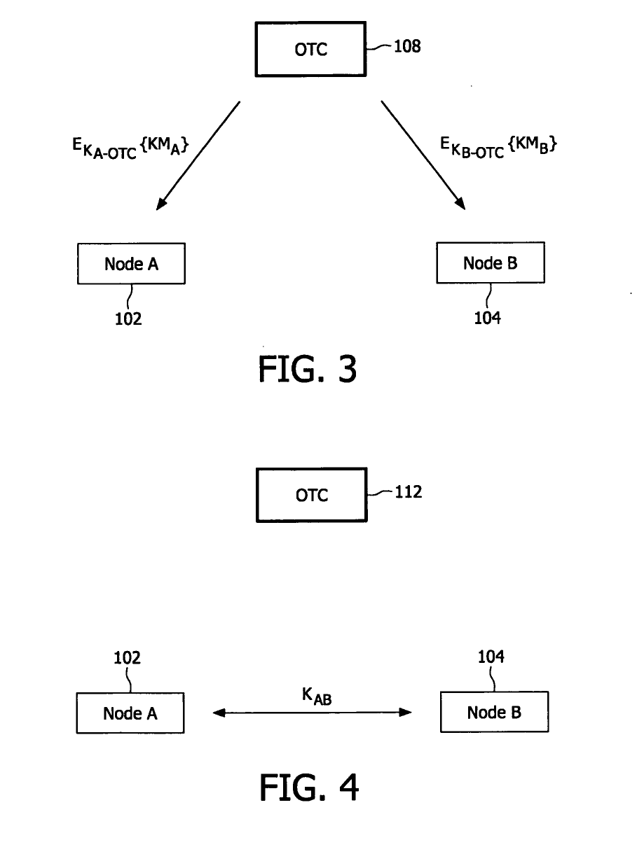

FIG. 3 shows a setup phase of a network according to the invention;

FIG. 4 shows an operational phase of a network according to the invention;

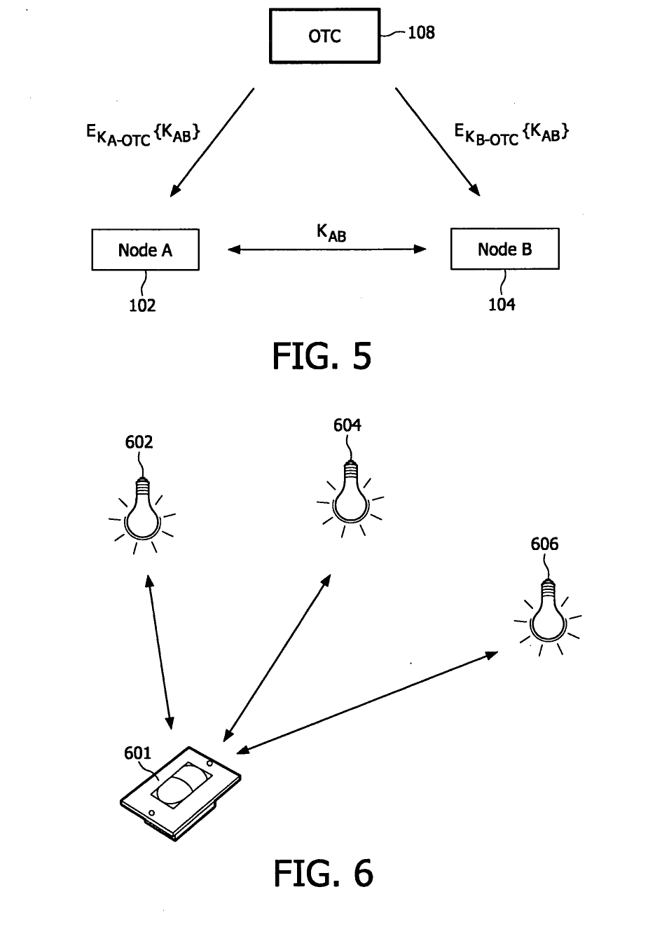

FIG. 5 shows a further network according to the invention; and

FIG. 6 shows a wireless control network.

In the following, functionally similar or identical elements may have the same reference numerals.

FIG. 1 shows a network according to an embodiment of the invention. The network may be a wireless control network. The network comprises a first node 102, a second node 104 and a further node 106. In case the network is a ZigBee® based network, the nodes 102, 104, 106 may be ZigBee® nodes. The network may comprise additional nodes and additional network means, like a trust center 108.

The nodes 102, 104, 106 may each comprise a pre-distributed keying material. The pre-distributed keying material was provided to the nodes 102, 104, 106 before the nodes were connected to the network. The pre-distributed keying material might be provided to the nodes 102, 104, 106 by an offline trust center which is not part of the network. After being connected to the network, the pre-distributed keying material may be replaced by a post-distributed keying material. The pre-distributed keying material allows the nodes 102, 104, 106 to establish a secure communication between each other. The communication link 112 may be established between the nodes 102, 104 autarchic without relying on the trust center 108. Thus, in case the trust center 108 is not available, the network can be established autonomously by the nodes 102, 104, 106. For establishing the communication link 112 the nodes 102, 104 may comprise additional means, like communication interfaces.

Each pre-distributed keying material may comprise a node identifier, a secret key and a basic set of keying material. The pre-distributed keying material of each of the nodes 102, 104, 106 may be configured to be only interoperable with the pre-distributed keying material of other nodes belonging to the same network, that is, pre-distributed keying material belonging to the nodes 102, 104, 106 of the same network.

In case the trust center 108 is available to the network, the trust center 108 may be configured to authenticate the nodes 102, 104, 106. The authentication may be performed after the nodes 102, 104, 106 are connected to the network. In order to authenticate one of the nodes 102, 104, 106, the trust center 108 may receive the pre-distributed keying material or a part of the pre-distributed keying material from the node 102, 104, 106 to be authenticated. Further, the trust center 108 may be configured to generate and provide post-distributed keying material to each of the nodes 102, 104, 106. The post-distributed keying material being provided to a pair of nodes 102, 104 may be correlated. The post-distributed keying material may be used by the nodes 102, 104, 106 to establish a secure communication. For example, the communication link 112 may be established between the nodes 102, 104 by using a pair of correlated post-distributed keying material being provide to the first node 102 and the second node 104 by the trust center 108. After the nodes 102, 104 have received the post-distributed keying material, they may establish the communication link without further relying on the trust center 108. The nodes 102, 104, 106 may be configured to replace their pre-distributed keying material by the post-distributed keying material received from the trust center. Alternatively, the nodes 102, 104, 106 may keep the pre-distributed keying material besides the post-distributed keying material.

According to an embodiment, the pre-distributed and/or the post-distributed keying materials may be generated by using the λ-secure approach. Alternatively, the keying material may be based on any other suitable keying technology. Depending on the keying technology, the nodes 102, 104, 106 may be configured to use the first and second pre-distributed and/or post-distributed keying materials to agree on a common secret key. The common secret key may be used to establish the secure communication between the nodes, for example the communication between the first node 102 and the second node 104.

FIG. 2 shows a flow diagram of a method for establishing a network according to an embodiment of the invention. In a first step a first node and a second node are provided. The nodes may be the nodes 102, 104 comprising pre-distributed keying material, as shown in FIG. 1. In a following step the network is established by establishing a secure communication between the first and the second node based on the first and second pre-distributed keying materials. The inventive method may be used for establishing a new network, for adding new nodes to an already established network or for establishing a new communication between nodes belonging to the same network.

The inventive approach implies a consistent and efficient key distribution architecture which may be used for wireless control networks. The main features of the key distribution architecture are described in the following by enumerating operational phases and main cryptographic and physical elements involved in the key distribution architecture. The operation of the key distribution architecture may be divided into two operational phases, a pre-deployment phase and a post-deployment phase.

The key distribution architecture may comprise wireless control network nodes that are configured to communicate with each other, an offline trust center used to pre-distribute basic cryptographic keying material at a factory for manufacturing the network nodes and a semi-online trust center used to configure the network nodes with cryptographic keying material when the network nodes join a wireless control network. The key distribution architecture may comprise all or a sub-set of the described physical elements.

Each network node i of the key distribution architecture may comprise a unique identifier i, an assigned secret Kᵢ or a set of secrets and an assigned keying material KMᵢ or a set of keying material. The assigned secret Kᵢ may be used to unambiguously authenticate the network node and to establish secure communications between the node and the trust center. Thus, the keying material allows the nodes to setup a secure communication without requiring the intervention of a trust center. According to the invention it is differentiated between keying material sets generated at the factory by the offline trust center (KMᵢ^{factory}) and keying material sets generated by an online trust center in the wireless control network (KMᵢ^{WCN}). The key distribution architecture may comprise all or a sub-set of the described physical elements.

The key distribution architecture operation may comprise a pre-deployment phase and a post-deployment phase. The post-deployment phase may include a network setup sub-phase and an operation mode sub-phase.

During the pre-deployment phase, an offline trust center may be used to pre-configure the nodes with basic keying material KMᵢ^{factory}. The pre-deployment phase takes place before the network nodes are sold or deployed, e.g. at the factory, in the integrator's inventory or on-site prior deployment. The cryptographic keying material for a network node i may include a node identifier i and a secret key Kᵢ or a set of secret keys. Both, node identifier i and secret key Kᵢ are stored, for example in a factory server in case the pre-deployment phase takes place at the factory. The cryptographic keying material may further comprise a basic set of keying material KMᵢ^{factory}. The basic set of keying material will enable a pair of nodes to establish a secure link without relying on a trust center after deployment.

The generated sets of keying material may be fully or partially interoperable. Fully interoperable factory keying material sets allow any pair of nodes {A,B}, which respectively own sets of keying material KM_{A}^{factory} and KM_{B}^{factory}, to establish a common secret by exploiting their keying material sets. In the situation of partially interoperable factory keying material sets, the offline trust center has information about the future deployment locations and/or other node characteristics, like function or type, of the wireless control network nodes. Nodes that are going to be deployed in different wireless control networks neither need nor must communicate with each other. Therefore, the offline trust center generates keying material in a way that the keying material sets KM_{A}^{factory} and KM_{B}^{factory} of two nodes {A,B} are only interoperable if and only if {A,B} belongs to a particular node set. Thus, interoperable means, the keying material sets can be used to agree on a common secret.

The cryptographic keying material distributed at the factory enables any node to be unambiguously authenticated, to be able to authenticate its identity and to setup a secure communication with a trust center as well as to establish a secure communication with other nodes without relying on a trust center.

The post-deployment phase may incorporate additional functionalities to the key distribution architecture. For instance, the post-deployment phase may enable the formation of different security domains within the same wireless control network. According to an embodiment, lighting nodes are deployed, for example, in a building after delivery of the lighting nodes. The post-deployment phase may comprise a network setup sub-phase and an operational mode sub-phase.

FIG. 3 shows a network setup sub-phase for a wireless control network comprising a first node 103 (Node A), a second node 104 (Node B) and an online trust center 108 (OTC). The wireless control network may comprise further means as described in FIG. 1. In the network setup-phase it is assumed that wireless control network nodes 102, 104 are deployed and that the trust center 108 takes the responsibility of managing the security relationships in the wireless control network. To this end, the trust center 108 may execute several steps including a node registration and a keying material distribution.

Node registration means, that the trust center 108, controlled by a network administrator, may register all nodes 102, 104 in the wireless control network. A possible method to register the nodes 102, 104 in a secure manner is based on the use of the cryptographic keying material pre-distributed in the pre-deployment phase. To this end, the trust center 108 may firstly authenticate the identity of each node 102, 104 based on the knowledge of the node secret key Kᵢ. Those keys are provided to the network administrator and/or the online trust center in a secure manner, for example by means of an SSL connection from the factory server after showing evidence of the purchase of those nodes 102, 104. Alternatively, the keys may be read from barcodes or RFID tags of the nodes 102, 104 or read in a secure environment over the air or out-of-band.

Keying material distribution means that the trust center generates and distributes correlated sets of keying material to each and every node i belonging to the wireless control network as shown in FIG. 3. According to the embodiment shown in FIG. 3, node i, with i: {A,B}, receives the keying material set KMᵢ^{WCN}. The trust center transmits keying material set KMᵢ^{WCN} to node i, with i: {A,B}, in a secure manner, i.e., by using the pre-distributed secret Kᵢ to ensure confidentiality and authentication. The keying material set KMᵢ^{WCN} might or might not substitute the pre-distributed set of keying material KMᵢ^{factory}.

FIG. 4 shows a network setup sub-phase for the wireless control network as shown in FIG. 3. In the operation mode sub-phase, the two nodes 102, 104 belonging to the wireless control network may establish a secure communication without requiring the intervention of the trust center 108. To this end, nodes {A,B} exploit their keying material sets, KM_{A}^{WCN} and KM_{B}^{WCN} respectively, to agree on a common secret K_{AB}. This common secret can be used to enable ad hoc device authentication by means of a challenge-response handshake. Afterwards, future communications between both nodes 102, 104 may be secured by using this secret or another secret derived from this one as shown in FIG. 3.

The post-deployment phase may comprise the sub-phases as described in FIG. 3 and FIG. 4 or a sub-set of these sub-phases.

The key distribution architecture according to the invention enables any pair of nodes belonging to the same wireless control network or security domain to setup a secure communication after pre-distribution of correlated keying material. The cryptographic primitives used in the key distribution architecture may be based on different symmetric techniques.

According to a first approach, the trust center would choose distinct keys for each pair among the n nodes in a wireless control network or security domain and may distribute to each node its n−1 keys. In this manner, a node is pre-configured with a common key shared with each node in the network.

λ-secure approaches are of special importance as they enable any pair of nodes to agree on a secret while guaranteeing that the coalition of a number of nodes lesser than λ does not compromise the security of the system. λ-secure approaches are the perfect solution as they allow for trading off between memory and security requirements: the higher the security level, the more the memory requirements.

The two approaches are described only exemplarily. The inventive approach is not restricted to the two described approaches.

FIG. 5 shows a ZigBee® key distribution architecture in a wireless control network comprising nodes 102, 104 and an online trust center 108 as described in FIG. 3. The inventive approach may be used to improve the ZigBee® key distribution architecture.

ZigBee® provides cryptographic mechanisms that enable authentication, authorization, confidentiality and integrity security services. However, the ZigBee® specification lacks an efficient, practical and secure key distribution architecture. The ZigBee® key distribution architecture is based on a centralized online trust center 108 whose participation in the key establishment process between any pair of nodes 102, 104 in the network is compulsory. According to the ZigBee® specification, when a pair of wireless control network nodes 102, 104 wants to establish a secure communication, the network nodes 102, 104 firstly have to communicate with the online trust center 108 in order to get a common application master key K_{AB}, that the nodes 102, 104 will use to communicate in a secure manner after performing the symmetric-key key exchange protocol. This is possible if each and every node i in the network shares a secret K_{i-OTC} with the online trust center 108. This secret is used to setup secure communication between a node 102, 104 and the online trust center 108, for example to securely transmit the network key. For instance, if the nodes 102, 104 want to start a communication, one of them must firstly send a request to the online trust center 108. The online trust center 108 uses the secrets K_{A-OTC} and K_{B-OTC} to securely transmit the new secret K_{AB} to the nodes 102, 104 respectively, for example by encrypting it, as shown in FIG. 5. Afterwards, the nodes 102, 104 can use K_{AB} to setup a secure communication as shown in FIG. 5.

The inventive approach may be used for enhancing the ZigBee® Security Architecture, as the two ZigBee® nodes {A,B} as shown in FIG. 5 need a common application master key K_{AB} to communicate in a secure manner. In particular, the inventive approach may be used to improve the part of the general ZigBee® specification which concerns the master key. Specifically, the use of the inventive approach would give new capabilities to the online trust center 108, so that the online trust center 108 would be able to give a set of keying material to each node 102, 104 when it joins the network as shown in FIG. 3. In this manner, nodes 102, 104 do not need anymore the intervention of the online trust center 108 to agree on a common key as shown in FIG. 4. This solution also reduces memory requirements if pre-distributed keying material is based on a λ-secure approach.

The original key material KMᵢ^{factory}, if established in factory, could remain available next to other key material sets KMᵢ^{WCN}, e.g. subject to user confirmation. Alternatively, it could be completely removed or reserved for special operation modes, e.g. only after factory reset.

Additionally, ZigBee® does not specify how to initialize a master key in the nodes 102, 104. This key is used to transmit in a secure manner, other keys such as, e.g., the application master key or network key to the nodes 102, 104. In this context, the inventive approach could be applied to ZigBee® in order to setup these master keys in a secure manner. More specifically, the key Kᵢ according to the present invention would play the role of the master key.

Furthermore, the entity authentication process being required by ZigBee®-2007 spec for high-security mode networks could be preformed using the key distribution architecture key material instead of the network key, thus providing for true authentication of every neighbour device and much more secure method for establishing frame counters between those devices to provide replay protection.

In addition, if node registration at the online trust center is not mandatory, assuming each node 102, 104 has the proper key material pre-installed and has appropriate operating configuration, either through self-organizing capabilities or pre-configuration, the inventive approach allows for piecemeal installation of networks, where any already deployed network part, like a room, a group of rooms, a floor or an application subnetwork can operate independently, without relying on availability of the online trust center 108.

This invention may find application in wireless control networks. Especially, it is applicable to any large-scale network, like lighting network or meter reading network. In general, this invention can be applied to any kind of 802.15.4/ZigBee® network. Additionally, the key distribution architecture might be applied to other wireless sensor networks applications in which the trust center is occasionally online.

Features of the described embodiments may be combined or used in parallel when suitable.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. Network, comprising:
a first node (102) comprising first pre-distributed keying material being assigned to the first node before the first node is connected to the network; and
a second node (104) comprising second pre-distributed keying material being assigned to the second node before the second node is connected to the network;
wherein the first node is configured to establish a secure communication (112) to the second node based on the first and second pre-distributed keying material, without relying on a trust center (108).

2. Network according to claim 1, wherein the first and second pre-distributed keying material each comprise a node identifier, a secret key and a basic set of keying material.

3. Network according to claim 1, wherein the first and second pre-distributed keying material are configured to be interoperable if the first and second nodes (102, 104) are assigned to the same network and are not interoperable if the first and second nodes are assigned to different networks.

4. Network according to claim 1, wherein the first and second pre-distributed keying material are assigned to the first and second node (102, 104) during manufacturing of the first and second node.

5. Network according to claim 1, further comprising the trust center (108) being configured to authenticate the first and the second nodes (102, 104) based on the first and second pre-distributed keying material.

6. Network according to claim 5, wherein the trust center (108) is configured to provide a first post-distributed keying material to the first node (102) and a second post-distributed keying material to the second node (104), wherein the first post-distributed keying material is correlated to the second post-distributed keying material and wherein the first node is configured to establish the secure communication (112) to the second node based on the first and second post-distributed keying material, without further relying on the trust center.

7. Network according to claim 5, wherein the first and second nodes (102, 104) are configured to replace the first and second pre-distributed keying material by the first and second post-distributed keying material.

8. Network according to claim 1, wherein the first and second pre-distributed and/or post-distributed keying materials are based on a λ-secure approach, a key pre-distribution scheme or a pair public/private key where the public key is authenticated by a certificate issued by the trust center.

9. Network according to claim 1, wherein the first and second nodes (102, 104) are configured to use the first and second pre-distributed and/or post-distributed keying material to agree on a common secret key usable by the first node to establish the secure communication to the second node.

10. Network according to claim 1, wherein the network is a wireless control network or a ZigBee® network.

11. Network according to claim 1, wherein the first and second node (102, 104) are ZigBee® nodes.

12. A node (102) for a network comprising:
a pre-distributed keying material being assigned to the node before the node is connected to the network;
wherein the node is configured to establish a secure communication (112) to at least one further node (104) of the network when the node is connected to the network and wherein the node is configured to establish the secure communication based on the pre-distributed keying material without relying on a trust center (108).

13. Method for establishing a network, comprising the steps of:
providing a first node (102) comprising first pre-distributed keying material being assigned to the first node before the first node is connected to the network;
providing a second node (104) comprising second pre-distributed keying material being assigned to the second node before the second node is connected to the network; and
establishing a secure communication (112) between the first and the second node based on the first and second pre-distributed keying materials, without relying on a trust center (108).

14. A computer program enabled to carry out the method according to claim 13 when executed by a computer.

15. A record carrier storing a computer program according to claim 14.

16. A computer programmed to perform a method according to claim 13 and comprising an interface for communication with a lighting system.
